(19) United States
(12) Patent Application Publication
(10) Pub. No.: US 2014/0310553 A1
(43) Pub. Date: Oct. 16, 2014

(54) HARDWARE AND SOFTWARE FOR SYNCHRONIZED DATA ACQUISITION FROM MULTIPLE DEVICES

(71) Applicants: Xun Chen, Fairlawn, OH (US); Kenneth Spikowski, Bay Village, OH (US)

(72) Inventors: Xun Chen, Fairlawn, OH (US); Kenneth Spikowski, Bay Village, OH (US)

(21) Appl. No.: 13/860,321

(22) Filed: Apr. 10, 2013

(51) Int. Cl. G06F 1/04

(52) U.S. Cl. CPC G06F 1/04
USPC 713/600

(57) ABSTRACT

A computer may assign a master device and at least one slave device. A program may direct the master device to broadcast counts based on its data acquisition clock. Then at least one slave device may receive the broadcast count and determine the difference between the clock count of the slave and the clock count of the master. The slave may use the difference of the counts to control the slave's voltage-controlled crystal oscillator.

### BACKGROUND OF THE INVENTION

The present invention relates to hardware and software for synchronized data acquisition from multiple devices.

Currently, it may be difficult to acquire synchronized data from multiple devices that may be physically separated. Usually, this process requires special interconnecting cables that may be limited in length by the hardware. Further, the process may require rewiring to configure membership in separate synchronized groups. Synchronized groups must be physically daisy-chained with all members and intermediate non-members operating and unavailable to other groups. Most factory floors are not daisy-chain compatible.

As can be seen, there is a need for a process of acquiring synchronized data without the reliance on inter-device cables.

### SUMMARY OF THE INVENTION

In one aspect of the present invention, a system for synchronizing data from a plurality devices, comprises: a computer controlling the plurality of device microprocessors; and a program product comprising machine-readable program code for causing, when executed, the computer and the plurality of devices to perform the following process steps: resetting a master counter in a master device; sending a first probe of the reset master counter to at least one slave device; resetting a slave counter of at least one slave device based on the probe; sending a second probe of the reset slave counter back to the master counter; determining travel delay based on the first probe and the second probe; latching and recording a local counter of the master device; broadcasting the master counter plus the travel delay to at least one slave; determining a difference between the broadcast counter and the slave counter; controlling at least one slave's voltage-controlled crystal oscillator (VCXO) based on the difference; sending data packets from the master and at least one slave to the computer.

These and other features, aspects and advantages of the present invention will become better understood with reference to the following drawings, description and claims.

### BRIEF DESCRIPTION OF THE DRAWINGS

FIG. 1 is a schematic flow diagram of the present invention; and

FIG. 2 is a schematic component diagram of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer that may assign a master device and at least one slave device. The software may control the computer to direct the master device to broadcast counts based on its data acquisition clock. Then at least one slave device may receive the broadcast count and determine the difference between the clock count of the slave and the clock count of the master. The slave may use the difference of the counts to control the slave's voltage-controlled crystal oscillator.

The present invention may include at least one computer with a user interface. The computer may be any computer including, but not limited to, a desktop, laptop, and smart device, such as a tablet and smart phone. The computer includes a program product including a machine-readable program code for causing, when executed, the computer to perform steps.

The present invention may include multiple devices connected using standard Ethernet or wireless routers or switches. The devices may contain microprocessors. The computer may determine which devices become masters or slaves. The devices may be flexibly configured by software into synchronized groups without the changing of cables. In certain embodiments, the present invention may be used with legacy networks with any type of connection, and allows the rest of the devices to be used when any of the others fail.

In certain embodiments, the present invention may use an Internet protocol suite including Transmission Control Protocol (TCP) and Internet Protocol (IP) data acquisition from multiple devices synchronized by User Data Protocol (UDP) broadcasts over a standard network. The present invention may include a master device that may broadcast counts of its data acquisition clock using UDP datagrams. In certain embodiments, the master UDP datagrams may contain unique keys for group identification of the slaves that receive the broadcasts.

In certain embodiments, the computer may reset the counter for both the master and the slaves. The master may broadcast its counter to the slaves. Each slave may control the frequency of the voltage-controlled crystal oscillator (VCXO) based on the difference between its local counter and master counter so that all devices have a synchronized count.

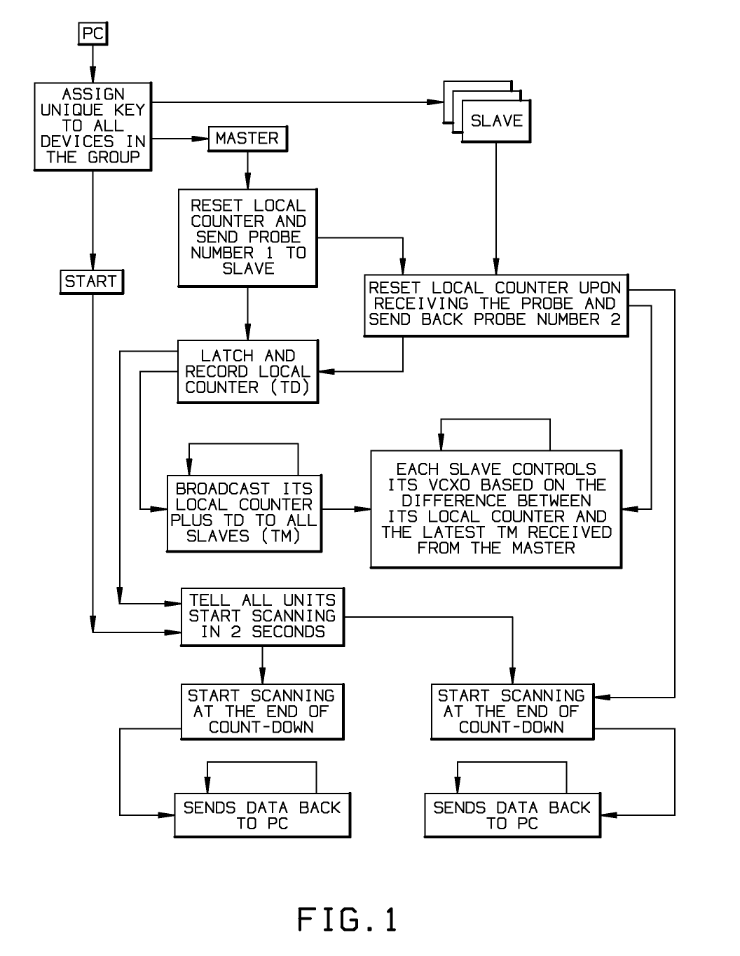

Referring now to FIG. 1, the present invention may include a computer. The computer may first assign a unique key for each group of devices, which may include the master and the slave devices. The master may reset the local counter and send a probe number 1 to the slave. The slave's counter may be reset based on the probe number 1 and the slave may send probe number 2 to the master. Probe number 1 and probe number 2 may be used to determine the datagram travel delay (TD) based on master counter.

The master device may latch and record the Local Counter, add travel delay (TD) to form a master counter (TM). The master counter (TM) may be broadcast to all of the slaves. This may be done via UDP datagrams. The master counter (TM) may be broadcast to the slaves in a continuous loop. The difference between the slave's local counter may be compared with the master counter (TM) broadcast from the master device. Each slave may control its voltage-controlled crystal oscillator (VCXO) using the difference between the slave's local counter and the master counter (TM) broadcast.

In certain embodiments, the present invention may include a scanning phase. The scanning phase of the present invention may include the continuous data conversion of analog to digital. The computer may start the scanning process once the keys have been assigned. The master may begin the scanning process after the latch and record of the travel delay (TD). The slaves may begin scanning once the slave's counter has been reset upon receiving the broadcast.

In certain embodiments, the scanning may occur at the end of a countdown. The countdown may account for the data transfer delay through the network. For example, the countdown may be a two second countdown. The slaves and master may begin scanning at the end of a countdown. Once the master and slave have been started to scan, the data is sent back to the PC. The process may occur in a continuous loop.

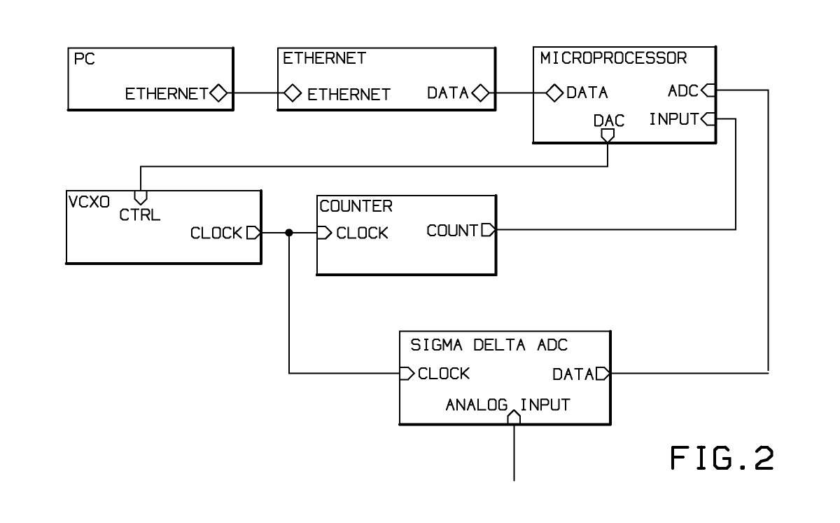

As mentioned above, the process may be implemented between a computer and multiple devices with microprocessors. The microprocessors may be part of either a master device or a slave device, which is determined by the computer. FIG. 2 provides a block diagram of either a master device or a slave device using the process of the present invention. The computer may link to the device over an Ethernet interface. The device may use the count that is inputted from the counter. In certain embodiments, when the device of FIG. 2 is a master device, the DAC may not use the difference of the count of the slave and the TM, and the DAC may set the VCXO at half range. In certain embodiments, when the device is a slave, the DAC output may be adjusted based on the difference between the count of the slave and the TM. The slave device may then control its VCXO based on the DAC. The VCXO frequency may then control the master clock of the Sigma-Delta analog-to-digital converters. The device reads the data from the ADC and sends the data back to the PC. This process may occur in a continuous loop.

The computer-based data processing system and method described above is for purposes of example only, and may be implemented in any type of computer system or programming or processing environment, or in a computer program, in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for synchronizing data from a plurality devices, comprising:
a computer controlling the plurality of device microprocessors; and
a program product comprising machine-readable program code for causing, when executed, the computer and the plurality of devices to perform the following process steps:
resetting a master counter for a master device;
sending a first probe of the reset master counter to at least one slave device;
resetting a slave counter of at least one slave device based on the probe;
sending a second probe of the reset slave counter back to the master device;
determining travel delay based on the first probe and the second probe;
latching and recording a local counter of the master device;
broadcasting the master counter plus the travel delay to at least one slave;
determining a difference between the broadcast counter and the slave counter;
controlling at least one slave's voltage-controlled crystal oscillator (VCXO) based on the difference.

2. The system of claim 1, wherein the program product further causes the devices to control a sample rate of the Sigma-Delta analog-to-digital converters using the VCXO frequency.

3. The system of claim 2, wherein the program product further causes the devices to buffer the data from the analog-to-digital converters and send the data back to the computer.

4. The system of claim 3, wherein the program product further causes the device to continuously perform data conversion in the form of scanning the data and sending the data back to the computer.

5. The system of claim 4, wherein the scanning occurs after a two second countdown.

6. The system of claim 1, wherein the synchronization messages are in form of User Datagram Protocol (UDP) packets.

7. The system of claim 1, wherein the process is continually repeated.
